(19) United States
(12) Patent Application Publication
(10) Pub. No.: US 2009/0303174 A1
(43) Pub. Date: Dec. 10, 2009

(54) CONTROL OF DUAL FUNCTION INPUT AREA

(75) Inventor: Vance Chin, San Francisco, CA (US)

Correspondence Address: Trellis Intellectual Property Law Group, PC, 1900 EMBARCADERO ROAD, SUITE 109, PALO ALTO, CA, 94303, US

(73) Assignee: OQO, Inc., San Francisco, CA (US)

(21) Appl. No.: 12/134,976

(22) Filed: Jun. 6, 2008

(51) Int. Cl. G09G 5/00

(52) U.S. Cl. 345/156

(57) ABSTRACT

An apparatus is provided that may be a portable device, such as a portable personal computer, cellular phone, or other computing device. The apparatus includes an input device. The input device may include a first input area and a second input area. The first and second input areas may occupy the same area of the computing device, such as the second input area may be underneath the first input area. A controller is provided that includes a first control area and a second control area. The first and second control areas may also occupy the same area where second control area may be underneath first control area. In one embodiment, first control area may be responsive to a mechanical input and a second control may be responsive to a non-mechanical input. The second control area is configured to enable and disable the second input area of the input device.

### BACKGROUND

Particular embodiments generally relate to computing devices and more specifically to input control for the computing devices.

As devices become smaller and smaller, adding more functions in less area becomes more important. One method of effectively using the real estate of a device is to provide a dual-purpose keyboard, which provides a keyboard with a capacitive sensor area underneath the keyboard. For example, the keyboard may be mechanically operated by the user pressing down on the keys. Also, the user may switch to using the capacitive sensor area at some point. In this case, the user may move their finger over the capacitive sensor area (and the keys) to control a pointing device on the display screen. For example, the capacitive sensor area may be a mouse area that controls the mouse or cursor on the screen. Thus, having the capacitive sensor area underneath the keyboard area allows the same area may be used as a keyboard and mouse.

### SUMMARY

In one embodiment, an apparatus is provided that may be a portable device, such as a portable personal computer, cellular phone, or other computing device. The apparatus includes an input device. The input device may include a first input area and a second input area. The first and second input areas may occupy the same area of the computing device, such as the second input area may be underneath the first input area. In one embodiment, the first input area may be responsive to a mechanical input and the second input area may be responsive to a non-mechanical input. For example, the input device may include a keyboard where keys are actuated to provide input and also a capacitive sensor area that allows control of a display, such as a pointing device displayed on the display. Other input devices may also be appreciated, such as single input devices, 2-D motion input devices (e.g., track pads, track sticks), 1-D motion input devices (pan, scroll, zoom), etc.

A controller is provided that includes a first control area and a second control area. The first and second control areas may also occupy the same area where second control area may be underneath first control area. In one embodiment, first control area may be responsive to a mechanical input and a second control may be responsive to a non-mechanical input. The first control area may include a mechanical key that may be actuated. The mechanical key may be equivalent to a mouse button that may be selected or depressed when using the second input area of the input device. The second control area is configured to enable and disable the second input area of the input device. Input to the second control area may indicate that the second input area should be enabled. For example, the second control area may be enabled using a capacitive sensor area where a user may hold his/her finger over the capacitive sensor area to enable the second input area of the input device.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a computing device according to one embodiment.

FIG. 2A-2D depict examples of an input device.

FIG. 3A shows an example of when capacitance may change according to one embodiment.

FIG. 3B shows a sensor structure according to one embodiment.

FIG. 4 depicts an example of using the computing device according to one embodiment.

FIG. 5 depicts an example of a method for operating the computing device according to one embodiment.

FIG. 6 shows an example device according to one embodiment.

### DETAILED DESCRIPTION OF EMBODIMENTS

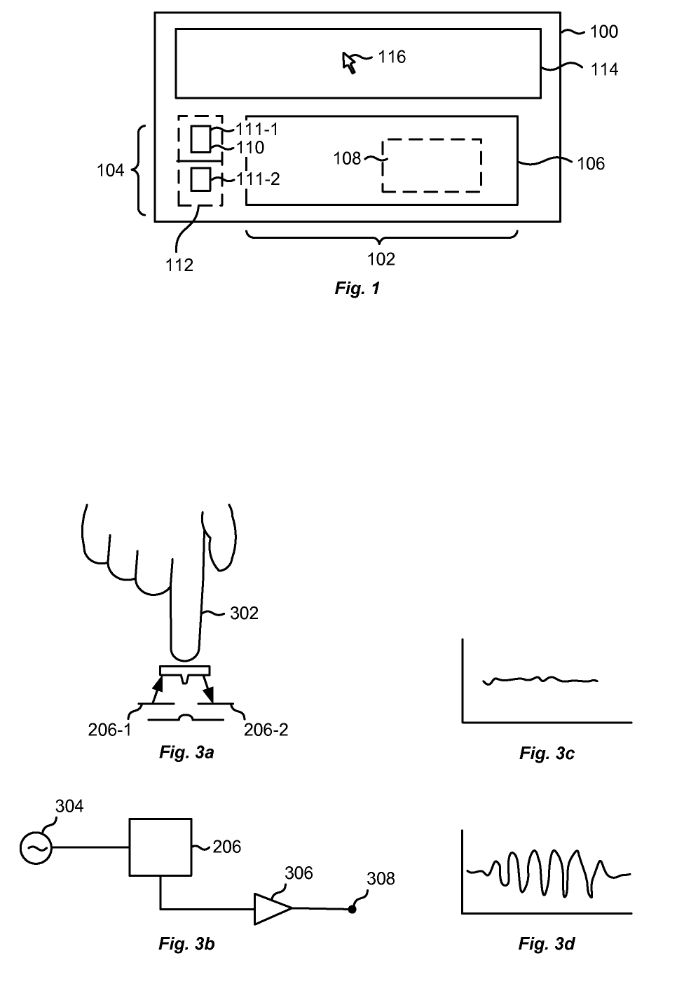

FIG. 1 depicts an example of a computing device 100 according to one embodiment. Computing device 100 may be a portable computing device, which may include a portable personal computer (PC), cellular phone, personal digital assistant (PDA), etc.

Computing device 100 may include an input device 102 and a controller 104. First input area 106 and second input area 108 may be located in substantially the same area. Thus, a certain surface area of computing device 100 may be used for both first input area 106 and second input area 108. For example, second input area 108 may have at least a portion of it underneath first input 106. This allows the same input device area to be used for two different functions. Thus, space is efficiently used on computing device 100 by providing two input areas in the same place.

First input area 106 and second input area 108 provide different ways of providing input. First input area 106 and second input area 108 may include different combinations of input devices. For example, input devices may include single input devices, 2-D motion input devices (e.g., track pads, track sticks), 1-D motion input devices (pan, scroll, zoom), etc. The input devices may be physical or capacitive. Different combinations may include two single input devices, an input button device and a 2-D motion device, a 1-D motion device and single input device, two 1-D motion devices, a 1-D motion device and a 2-D motion device, a 2-D motion device and a single input device, two 2-D motion devices, etc. It should be noted that input devices in the combinations may be switched in first input area 106 or in second input area 108.

The single input devices may be devices that provide a single input, such as a selection or click. This may be a binary input, such as a “1” or “0”. In one example, a number of selection buttons can be selected. The input buttons may be physical or soft keys. The selection buttons allow a user to select the buttons. For example, the buttons may be right and/or left keys that can be “clicked” or selected.

The 1-D motion input device provides movement in one dimension. For example, the 1-D input device allows a user to control a user interface to pan, scroll, or zoom. The 1-D motion input device may be physical or capacitive.

The 2-D motion input device provides movement in two dimensions. For example, the 2-D input device may include a trackpad or trackstick.

In one embodiment, first input area 106 is responsive to a mechanical input and the second input area 108 is responsive to non-mechanical input. For example, input area 106 may include a keyboard in which keys are physically actuated to provide input. That is, the keys may be physically depressed by a user to provide the input.

In one embodiment, second input area 108 may use sensors that sense input. The input that is sensed may be electrical signals or changes in electrical signals. This may be referred to as a non-mechanical input or the input may be electrically sensed. In this case, mechanical actuation may not be needed; however, some kind of mechanical actuation may also be used in some embodiments. In one example, second input area may be a capacitive sensor area. The capacitive sensor area senses changes in capacitance that may occur. For example, a user may place their finger or thumb (generally referred to as a digit) across the second input area 108 to provide the input. Capacitance changes are detected and used to determine when an input has occurred. The structure of a capacitive sensor area will be described in more detail below. Although a capacitive sensor area is described, it will be understood that other input methods may be used. For example, laser emitting diodes, a touchscreen, or any other apparatus may be used.

First input area 106 and second input area 108 may be used to provide different functions. A function may be any action or purpose that can be controlled using first input area 106 and second input area 108. In one embodiment, first input area 106 provides any input from a keyboard. This may include typing, control of a display 114, etc. Other inputs may be controlling a pointer on display 114 in two dimensions, scrolling the screen up and down, or right to left, clicking on a mouse button, etc.

In one embodiment, second input area 108 provides control of display 114. For example, second input area 108 is used to control a pointing device 116 on display 114. When a user moves his/her digit (or another pointing device, such as a stylus) back and forth across second input area 108, pointing device 116 may be moved based on the input. Also, other functions may be provided by second input area 108, such as the scrolling of content shown on display 114, control of a cursor shown in a document, etc. In one embodiment, second input area 108 provides two-dimensional control over an object in display 114.

Controller 104 may include a first control area 110 and a second control area 112. In other embodiments, variations of controller 104 may be appreciated. For example, only second control area 112 may be used, multiple control areas may be used, etc. Controller 104 is configured to enable/disable second input area 108 in the different variations. As shown, at least a portion of second control area 112 is in the same area as first control area 110. Thus, a certain surface area of computing device 100 may be used for both first control area 110 and second control area 112. This also saves area on computing device 100. Second control area 112 may also extend further outside of first control area 110 but it is not necessary.

First control area 110 and second control area 112 may be responsive to different or the same inputs. For example, first control area 110 may be responsive to a mechanical input and second control area 112 may be responsive to a non-mechanical input. First control area 110 may be an input that may be typically used in conjunction with second input area 108. For example, first control area 110 may include mouse buttons similar to a right click and left click found on a mouse. For example, buttons 111-1 and 111-2 may be used to indicate a selection of content on display 114. As pointing device 116 is moved around display 114, button 111-1 may be depressed. This may be akin to selecting the left mouse button of a conventional mouse. Also, button 111-2 may be depressed and may provide a function akin to the right mouse button on a conventional mouse. In other embodiments, other functions are associated with buttons 111. However, in most cases, a user may typically use buttons 111 when using second input area 108. For example, a user may be moving pointing device 116 around display screen 114 and it is likely that user may want to use buttons 111 at some point.

By having second control area 112 underneath first control area 110, second input area 108 is in a convenient area for user to provide input to it. For example, because a user may be likely to use buttons 111 when using second input area 108, then a user may naturally position their digit over second input area 108. That is, a user may naturally have his/her thumb over button 111-1 when using second input area 108 because the user may be using buttons 111 or may be naturally holding device 100 in that way. Thus, enabling second input area 108 is provided in a position and way that naturally user may position their digit.

Second control area 112 is configured to enable and disable second input area 108. For example, because input device 102 a dual-function input area, an indication as to which of first input area 106 and second input area 108 should be activated is needed. For example, when using a keyboard, the user may not put want their mouse pad located underneath the keyboard to be active because unwanted movement of pointing device 116 may occur. Accordingly, when an input is received for second control area 112, second input area 108 is enabled and first input area 106 is disabled. For example, a user may hold their digit over second control area 112 to enable second input area 108. If second control area 112 is a capacitive sensor area, then electrical changes are detected that may enable second input area 108. The user may then move their finger around second input area 108 to control pointing device 116 on display 114. Also, a keyboard is not active at this time; however, the keyboard could be active to allowing typing and mouse control at the same time.

Second control area 112 may extend in between button 111-1 and button 111-2. This may be because a user may move his/her thumb and/or finger in between buttons 111-1 and 111-2. For example, at some point while using second input area 108, a user may want to use button 111-1 and then the user may move his/her thumb to button 111-2. A user may want to continuously have second input area 108 enabled while moving in between buttons 111. Thus, second control area 112 is provided in between buttons 111 so that control is not lost. Also, second input area 112 may extend out beyond buttons 111 to allow the user more space to in place his/her thumb to provide input to second control area 112.

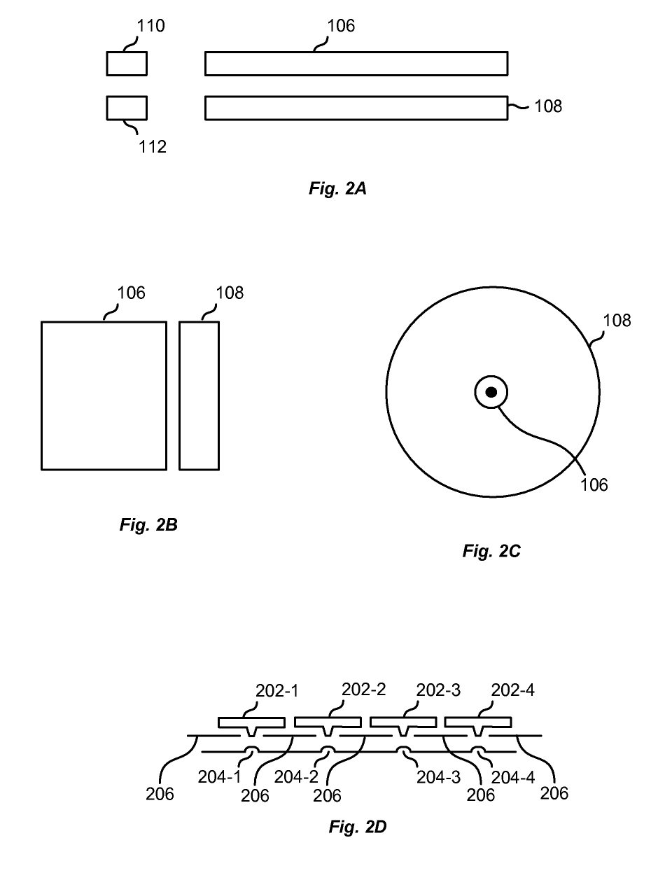

FIG. 2A depicts a side view of input device 102 according to one embodiment. As shown, first input area 106 is situated on top of second input area 108. In this case, second input area 108 may be activated using second control area 112. Because first input area 106 is above second input area 108, second control area 112 is used to determine which input area a user desires to activate.

FIG. 2B depicts an example of input device 102 according to one embodiment. As shown, first input area 106 is next to second input area 108. Thus, first input area 106 does not have to be underneath second input area 108. Because of the proximity of second input area 108 to first input area 106, it might be desirable for a user to specify which input area he/she desires to activate using second control area 112. In this case, a 2-D input device and a 1-D input device are used. In another embodiment, second control area 112 does not have to be underneath first control area 110 also.

FIG. 2C depicts another example of input device 102 according to one embodiment. As shown, first input area 106 is in the middle of second input area 108. Thus, first input area 106 does not have to be fully underneath second input area 108 (it may be partially underneath or in this case, protruding from). Because of the proximity of second input area 108 to first input area 106, it might be desirable for a user to specify which input area he/she desires to activate using second control area 112. In this example, a trackstick is found in the middle of a scrollwheel. Either the scrollwheel or trackstick may be activated using second control area 112. In another embodiment, instead of a trackstick, a single input button may be used in the middle of the scrollwheel.

FIG. 2D depicts a more detailed example of input device 102 according to one embodiment. As shown, keys 202 are provided that may be actuated by depressing them to contact connection points 204. For example, when key 202 is depressed, it contacts connection point 204-1. Thus, an input is received indicating that a user has depressed key 202-1. For example, if this key was associated with the letter “a”, then the letter “a” may be displayed on display 114. Other functions may also be provided using keys 202.

As shown, sensors 206 may be provided under keys 202. Sensors 206 may be part of a capacitive sensor area that senses a change in capacitance. For example, if a ground point, such as a finger, is placed in between two sensors, then a change in capacitance may occur.

FIG. 3A shows an example of when capacitance may change according to one embodiment. In one embodiment, sensors 206 in the form of a transmitter 206-1 and a receiver 206-2 are provided. When a digit 302 is moved near transmitter 206-1 and receiver 206-2, some of an electric field may be shunted away. Because sensors 206 are underneath keys 202, a digit may not physically touch sensors 206. The sensitivity for sensors may be changed depending on how thick keys 202 are. For example, if keys 202 are thicker, then sensors 206 may need to be able to sense the presence of a digit at larger distances away from sensors 206. The sensitivity of sensors 206 may be easily adjusted. Also, it will be understood that a user may touch sensors 206 to provide input. For example, some areas of second control area 112 may be exposed from underneath keys 202. In either case, the sensing of a capacitance change may be determined.

As shown in FIG. 3B, a sine wave 304 may be applied to one of the sensors 206. The output of the sensor may be input into an amplifier 306. The electrical signal may be measured at 308. When a digit is not present in the area of transmitter 206-1 and receiver 206-2, then a signal may be small, such as shown in FIG. 3C. However, when the finger is moved as shown in FIG. 3A, the signal may increase. When the signal increase is detected, then it is determined that a non-mechanical input has been received.

In other embodiments, a matrix approach may be applied where a series of conductors are arranged in an array of parallel lines in two layers, separated by an insulator. When a ground, such as a finger, is placed over one of the intersections between the conductive layer, some of the electrical field lines are shunted at this point. This results in a change in capacitance at that location. Although the above methods are described, it will be understood that other methods of detecting a non-mechanical input may also be provided.

In another embodiment, first input area 106 may be reconfigurable. For example, first input area 106 may include a screen (e.g., a touchscreen) that can provide multiple functions. For example, at one point, the screen displays keys that can be used as a keyboard. When second control area 112 is enabled thus enabling second input area 108, the screen may be used as a mouse pad. For example, as is known, movement over the screen is detected and used to move pointer 116. In one example, the structures to detect input from first input area 106 and second input area 108 may be the same. Thus, changes in electrical signals are detected, but the changes cause different input functions to be applied (e.g., the input of keys or the movement of a mouse). In another embodiment, even if a touchscreen is used, second input area 108 may be underneath first input area 106.

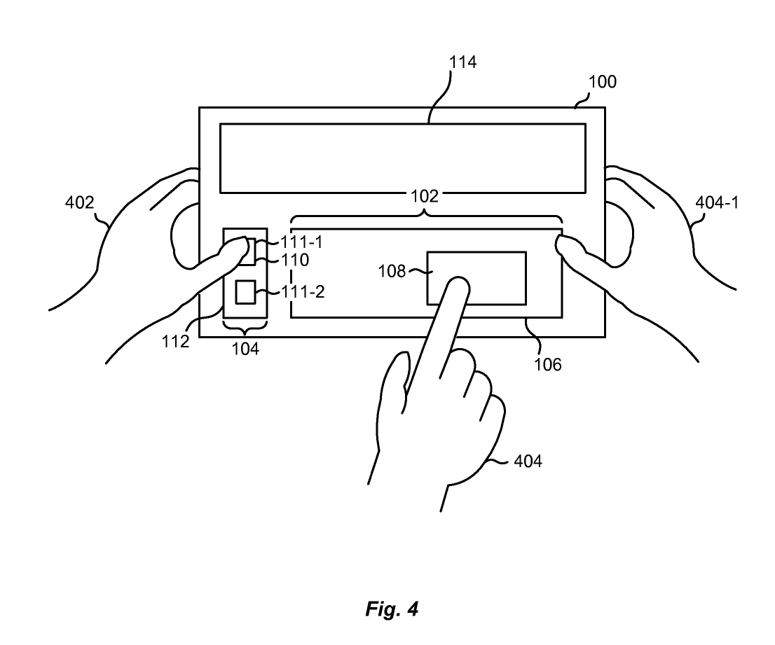

FIG. 4 depicts an example of using computing device 100 according to one embodiment. As shown, a user's left hand 402 may hold computing device 100 on the left-hand side and the user may hold a right hand 404 on the right-hand side of computing device 100. For example, a user's fingers may be behind computing device 100 and a thumb may rest over the control area 104.

A user may use both of his/her thumbs to use first input area 106. For example, a user may use his/her thumbs to actuate the keys on a keyboard as shown by right hand 404-1. In this case, the user's left-hand thumb may be also using the keyboard when the user is typing in the message. When a user wants to use second input area 108, the user may move his/her thumb to be over controller 104. This may be because the user wants to use first control area 110 at some point. For example, users typically use mouse input keys when using a pointer control. In this case, the user's thumb may be over second control area 112 and thus enables second input area 108. The user may then use his/her digit to provide input to a second input area 108 as shown by 404-2. For example, a finger may be moved across second input area 108 to move pointer 116.

Because the user's thumb may be naturally in the position over control area 104, it is convenient to have second control area 112 in that position. Further, because the input is a non-mechanical input, such as the capacitance area, enabling second input area 108 is convenient and quick. This also allows the user to automatically know when second input area 108 is enabled. For example, if a user's thumb is not over second control area 112, then the user knows that second input area 108 is not enabled. This is intuitive for a user to figure out. However, if a hard switch was used to enable second input area 108, such as if the user had to input a code, toggle a key, flip a switch, etc., the user might have to look at display 114 to see if second input area 108 is enabled. For example, an icon may be displayed similar to when caps lock is on to show that second input area 108 is enabled. However, using particular embodiments, the user intuitively knows when second input area 108 is enabled because he/she can tell automatically if his/her thumb is over second control area 112.

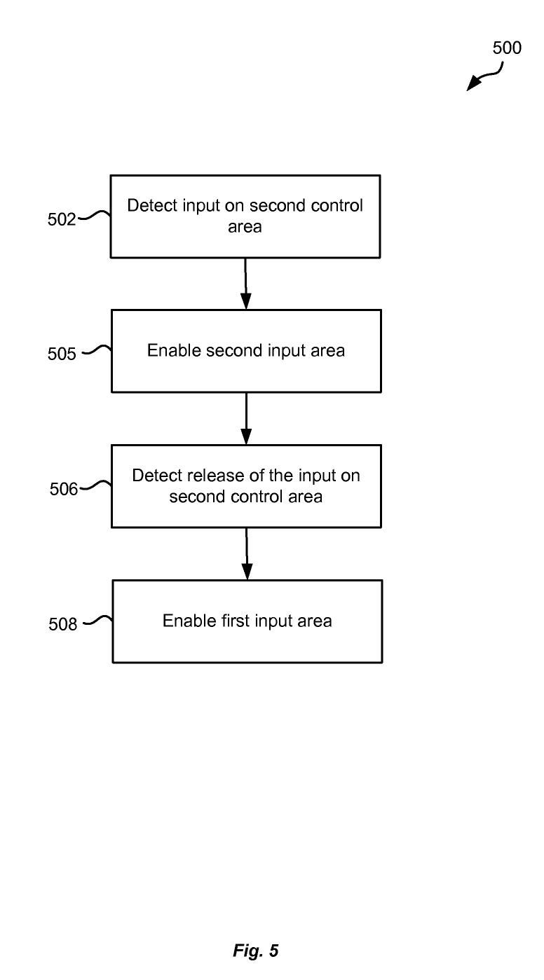

FIG. 5 depicts an example of a method for operating computing device 100 according to one embodiment. Step 502 detects input on second control area 112. The input may be detected as described above.

Step 504 enables second input area 108. For example, a user may now control pointing device 116.

Step 506 detects release of the input on second control area 112. For example, the user may move his/her thumb away from second control area 112.

Step 508 then enables first input area 106. For example, the user may now type on a keyboard. Accordingly, efficient and quick control of second input area 108 is provided. A user may switch between first input area 106 and second input area 108 quickly and efficiently.

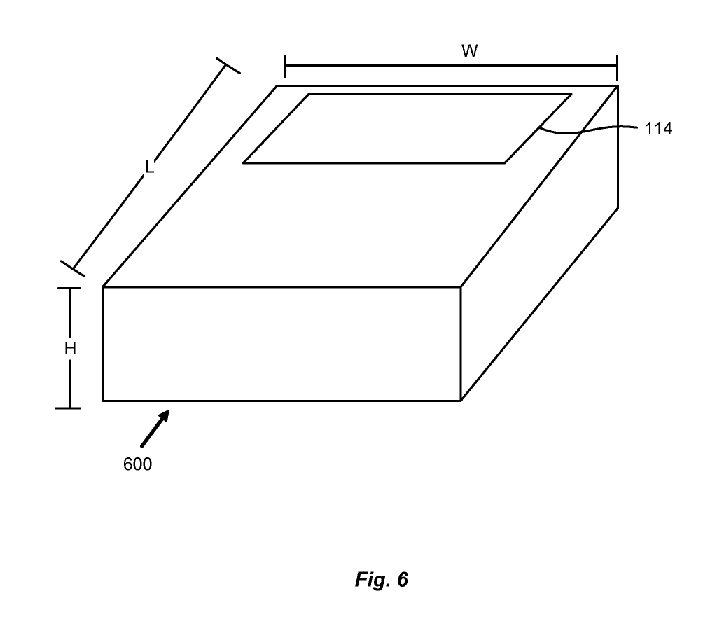

FIG. 6 shows an example device 100 according to one embodiment. In one embodiment, device 100 may be a portable device. For example, device 100 may include a miniature computer, laptop computer, personal computer, personal digital assistant (PDA), cellular telephone, Blackberry device, pocket PC, etc. In other embodiments, device 100 is not limited to portable devices and may be used in any display device, such as a laptop computer, television, DVD display player, etc.

In one embodiment, the dimensions of device 100 may be a length, L, of substantially 4 inches; a width, W, of substantially 3 inches; and a height, H, of substantially ¾ inches. Additionally, the display may be a little under substantially 3 inches wide and substantially 4 inches long.

Particular embodiments provide many advantages. For example, two input areas are provided in the same area. In one embodiment, a keyboard is provided in addition to a second input area that is found underneath the keyboard. Thus, space is saved to provide a dual-function input device 102. Because first and second input areas are provided in the same area, a method to switch between the two is provided that is quick and efficient. That is, user can enable and disable second input area 108 quickly by placing a digit over second control area 112. Second control area 112 is provided in a place that a user may typically put their thumb and/or finger when using second input area 108. For example, second input area 108 is put under a mouse selection button.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. An apparatus comprising:
an input device for providing input to the apparatus, the input device including a first input area and a second input area, wherein at least a portion of the second input area and the first input area are used in a same first area in the apparatus; and
a controller, the controller including a first control area and a second control area, wherein at least a portion of the second control area and the first control area are used in a same second area in the apparatus, the second control area being responsive to an input and configured to enable and disable the second input area of the input device based on the input.

2. The apparatus of claim 1, wherein the input device comprises a keyboard and a display controller for a display.

3. The apparatus of claim 2, wherein the display controller is configured to control a pointing device.

4. The apparatus of claim 1, wherein the first input area comprises one of a single input device, a 1-D motion input device, and a 2-D motion input device and the second input area comprises one of a single input device, a 1-D motion input device, and a 2-D motion input device.

5. The apparatus of claim 1, wherein the second input area is responsive to an electrically sensed input.

6. The apparatus of claim 5, wherein the second input area comprises a capacitive sensor area.

7. The apparatus of claim 1, wherein the second control area is responsive to an electrically sensed input.

8. The apparatus of claim 1, wherein the first control area is used with the second input area to provide input.

9. The apparatus of claim 1, wherein at least a portion of the second control area is substantially under the first control area.

10. The apparatus of claim 1, wherein at least a portion of the second input area is substantially under the first input area.

11. A method comprising:
receiving a first input for a second control area, wherein at least a portion of the second control area and the first control area are used in a same first area in a computing device;
disabling a first input area of the computing device based on the first input;
enabling a second input area of the computing device based on the first input, wherein at least a portion of the second input area and the first input area are used in a same second area in the computing device;
receiving a second input in the same second area in the computing device; and
applying the second input to a function for the second input area.

12. The method of claim 11, wherein applying the second input to the function comprises controlling a two dimensional pointing device.

13. The method of claim 11, further comprising:
detecting a removal of the first input for a second control area;
enabling the first input area of the computing device based on the removal of the first input;
disabling the second input area of the computing device based on the removal of the first input;
receiving a third input in the same second area in the computing device; and
applying the third input to a second function for the first input area.

14. The method of claim 13, wherein applying the third input comprises applying an action based on a keyboard input.

15. The method of claim 11, wherein the first input and second input comprise an electrically sensed input.

16. The method of claim 11, wherein the first input area comprises one of a single input device, a 1-D motion input device, and a 2-D motion input device and the second input area comprises one of a single input device, a 1-D motion input device, and a 2-D motion input device.

17. The method of claim 11, wherein at least a portion of the second control area is substantially under the first control area.

18. The method of claim 11, wherein the first control area includes a plurality of inputs, wherein the second control area is included in an area in between the plurality of inputs.

19. The method of claim 11, wherein at least a portion of the second input area is substantially under the first input area.

20. A portable computing device comprising:
a display screen;
an input device for providing input to the computing device, the input device including a keyboard area and a sensor area, wherein at least a portion of the keyboard area and the sensor area are used in a same first area in the portable computing device; and
a controller, the controller including a first control area and a second control area, wherein at least a portion of the second control area and the first control area are used in a same second area in the portable computing device, the second control area being responsive to an input and configured to enable and disable the sensor area of the input device based on the input.
